(19) United States
(12) Patent Application Publication
(10) Pub. No.: US 2023/0349110 A1
(43) Pub. Date: Nov. 2, 2023

(54) SYSTEM FOR PREDICTING MAINTENANCE FOR ENDLESS FLEXIBLE MEMBERS USABLE AS CONVEYORS IN MACHINES

(71) Applicant: Caterpillar Paving Products Inc., Brooklyn Park, MN (US)

(72) Inventors: Eric S. Engelmann, Delano, MN (US); Timothy M. O'Donnell, Long Lake, MN (US); Brian J. Schlenker, Shoreview, MN (US)

(73) Assignee: Caterpillar Paving Products Inc., Brooklyn Park, MN (US)

(21) Appl. No.: 17/661,132

(22) Filed: Apr. 28, 2022

(51) Int. Cl. E01C 23/088; B60Q 9/00; B65G 43/02; G01B 21/32

(52) U.S. Cl. CPC E01C 23/088; B60Q 9/00; B65G 43/02; G01B 21/32; E01C 23/127

(57) ABSTRACT

A system for predicting maintenance of an endless flexible member of a road construction machine. The system includes a sensor and a controller. The sensor detects a distance between a frame portion and a roller portion. The roller portion is movable with respect to the frame portion to tension the endless flexible member, which is configured to convey materials or power in the road construction machine. The controller is communicably coupled to the sensor. The controller is configured to compute a change in the distance over time between the frame portion and the roller portion that is required to maintain proper working tension on the endless flexible member; and generate alerts when a value associated with the change in the distance exceeds one or more predetermined threshold values.

### TECHNICAL FIELD

The present disclosure relates to endless flexible members usable as conveyors in machines, such as road construction machines. More particularly, the present disclosure relates to a system for predicting maintenance or service for such endless flexible members.

### BACKGROUND

Construction machines, such as cold planers, asphalt pavers, and the like, are commonly applied on roadways to reform or refurbish a roadway. Such machines generally include one or more endless flexible members to convey materials within or out of the machines. For example, in a cold planer, an endless flexible member may be applied in the form of a conveyor belt to convey milled materials from a milling chamber to a dump location, while in an asphalt paver, an endless flexible member may be applied in the form of a conveyor chain to convey a paving material, such as bitumen, to an underside of a screed so as to spread the paving material on a surface for compaction. In some machines, endless flexible members may be applied in the form of belt drives to convey power from a power source to an implement to run the implement.

Endless flexible members, such as the ones discussed above, and otherwise, are generally maintained under tension to function properly. Owing to rigorous and/or harsh operational conditions, such endless flexible members may experience wear and degradation over a period. Negligence in timely and appropriately inspecting a state of such endless flexible members for wear and/or replacement results in unexpected failure or tear of such endless flexible members, in turn leading to reactive maintenance or service, unplanned machine downtime, and loss of production.

U.S. Pat. No. 10,611,577 relates to a cold planer that includes a conveyor system. The conveyor system includes a conveyor belt that rotates about a conveyor roller. A belt tensioning system is coupled to the conveyor roller and includes an actuator for moving the conveyor roller to place tension on the conveyor belt. One or more processors are configured to receive information related to the conveyor belt and adjust the actuator based on the information related to the conveyor belt to provide a constant operating tension on the conveyor belt.

### SUMMARY OF THE INVENTION

In one aspect, the disclosure relates to a system for predicting maintenance of an endless flexible member of a road construction machine. The system includes a sensor and a controller. The sensor detects a distance between a frame portion and a roller portion. The roller portion is movable with respect to the frame portion to tension the endless flexible member, and the endless flexible member is configured to convey materials or power in the road construction machine. The controller is communicably coupled to the sensor. The controller is configured to compute a change in the distance over time between the frame portion and the roller portion that is required to maintain proper working tension on the endless flexible member; and generate one or more alerts when a value associated with the change in the distance exceeds one or more predetermined threshold values.

In another aspect, the disclosure is directed to a road construction machine. The road construction machine includes a chassis, an implement assembly supported by the chassis, a power system to generate and convey power to the implement assembly for a road construction operation, a conveyor system to convey materials produced from the road construction operation to a dump location, an endless flexible member to convey the power or the materials, and a frame portion and a roller portion. The roller portion is movable with respect to the frame portion to tension the endless flexible member. The road construction machine includes a system for predicting maintenance of the endless flexible member. The system includes a sensor and a controller. The sensor detects a distance between the frame portion and the roller portion. The controller is communicably coupled to the sensor and computes a change in the distance over time between the frame portion and the roller portion that is required to maintain proper working tension on the endless flexible member. Further, the controller generates one or more alerts when a value associated with the change in the distance exceeds one or more predetermined threshold values.

In yet another aspect, the disclosure relates to a method for predicting maintenance of an endless flexible member of a road construction machine. The method includes detecting, by a sensor, a distance between a frame portion and a roller portion. The roller portion is movable with respect to the frame portion to tension the endless flexible member and the endless flexible member is configured to convey materials or power in the road construction machine. The method includes computing, by a controller, a change in the distance over time between the frame portion and the roller portion that is required to maintain proper working tension on the endless flexible member. Further, the method includes generating one or more alerts when a value associated with the change in the distance exceeds one or more predetermined threshold values.

### BRIEF DESCRIPTION OF THE DRAWINGS

FIG. 1 is a view of an exemplary road construction machine that includes an implement assembly and a conveyor system for the implement assembly, in accordance with an embodiment of the present disclosure;

FIGS. 2 and 3 are a close-up views of the conveyor system having a system to predict a maintenance of an endless flexible member of the conveyor system, in accordance with various embodiments of the present disclosure;

FIG. 4 is a schematic view of the system, in accordance with an embodiment of the present disclosure; and

FIG. 5 is a flowchart illustrating a method for predicting a maintenance of an endless flexible member of the conveyor system, in accordance with various embodiments of the present disclosure.

### DETAILED DESCRIPTION

Reference will now be made in detail to specific embodiments or features, examples of which are illustrated in the accompanying drawings. Generally, corresponding reference numbers may be used throughout the drawings to refer to the same or corresponding parts, e.g., 1, 1′, 1″, 101 and 201 could refer to one or more comparable components used in the same and/or different depicted embodiments.

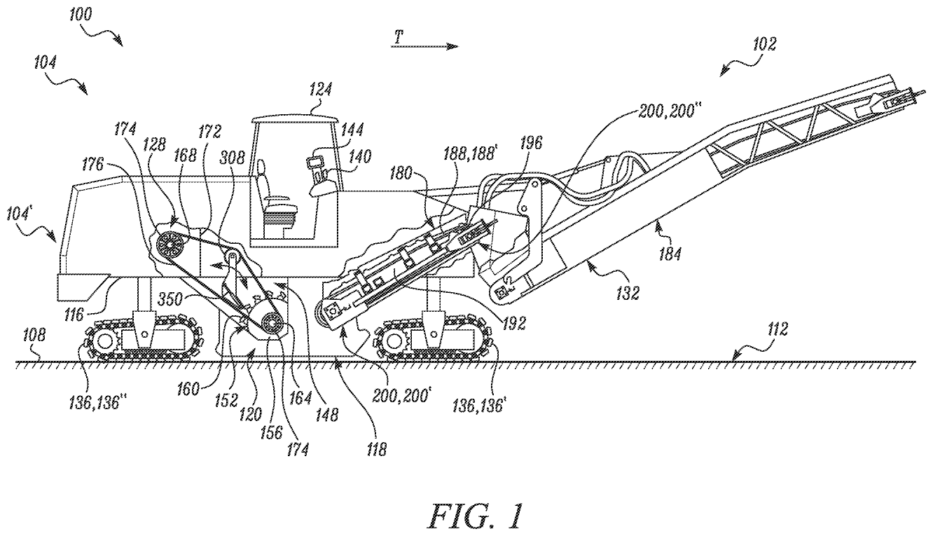

Referring to FIG. 1, a machine 100 is shown. The machine 100 may include a road construction machine 102, e.g., a milling machine 104, such as a roadway/pavement profiler, a roadway planer, and/or the like. As an example, the milling machine 104 includes a cold planer 104′. The machine 100 may be used to perform a road construction operation, such as a milling operation to modify a ground surface 108. For example, the milling operation may mean or include one or more of scarifying, removing, mixing, and/or reclaiming material, from the ground surface 108. The ground surface 108 may be a worn out surface of a roadway 112, formed from one or more of asphalt, bitumen, concrete, and/or other road surface materials. One or more layers of the ground surface 108 may be milled and removed by way of the aforesaid milling operation for the laying of a new ground surface (e.g., by an asphalt paver).

Although the machine 100 may include a milling machine, one or more aspects of the present disclosure may be usable in other machines, such as in asphalt pavers, and/or in other applications, as well. Such uses will become apparent to those skilled in the art based on the description below. The machine 100 may include a main frame or a chassis 116, an implement assembly 118 or a milling assembly 120, an operator station 124, a power system 128, a conveyor system 132, and a set of traction devices 136.

The traction devices 136 may support the chassis 116 over the ground surface 108. The traction devices 136 may be powered by the power system 128 to propel the machine 100 (e.g., the milling machine 104) over an expanse of the roadway 112. The traction devices 136 may include crawler tracks, wheels, or a combination thereof. Exemplarily, the machine 100 may include four traction devices (e.g., one towards each corner of the chassis 116 of the machine 100), although lesser or higher number of traction devices 136 may be contemplated. As an example, the traction devices 136 may include forward traction devices 136′ and rearward traction devices 136″. In some embodiments, the traction devices 136 may be adjustably supported on the chassis 116 and may be moved or varied independently with respect to the chassis 116, such that a distance (e.g., a height) of the chassis 116 relative to the ground surface 108, may be varied relative to the traction devices 136, allowing the chassis 116 to acquire a desired height and/or a desired orientation with respect to the ground surface 108.

The operator station 124 may be able to accommodate one or more operators of the machine 100, and may further include one or more controls 140, which may include control one or more of panels, levers, steering units, etc., and one or more input/output devices 144 that may include one or more of displays, audible units, touchscreens, and the like. An input to initiate a working of the machine 100 and/or an input to initiate one or more functions of the machine 100, such as the milling operation, may be provided by accessing one or more of the controls 140 and/or the input/output devices 144 in the operator station 124. In some cases, the machine 100 may be a semi-autonomous or a fully-autonomous machine, and, in such a case, the operator station 124 may be deployed remotely to the machine 100.

The milling assembly 120 may be supported by the chassis 116 and may be configured to facilitate the milling operation. The milling assembly 120 may include a milling chamber 148 and a milling drum 152. The milling chamber 148 may be supported by and/or be suspended under the chassis 116 of the machine 100 enabling the milling assembly 120, generally as a whole, to acquire a position under the chassis 116, as shown. The milling chamber 148 may define an enclosure that may function to confine and restrict a spread of disintegrated particles and/or the milled materials produced during the milling operation within the enclosure (or within a boundary) defined by the milling chamber 148.

The milling drum 152 may be housed within the milling chamber 148. The milling drum 152 may be applied to engage and mill the ground surface 108 during the milling operation so as to produce or obtain the milled materials and thus a milled roadway surface. The milling drum 152 may include a drum portion 156 (e.g., a cylindrical drum portion) and cutter tools 160 arranged over and around the drum portion 156. Further, the milling drum 152 may include a driveshaft 164 fixedly coupled to the drum portion 156. During a milling operation, the milling drum 152 may be powered (e.g., mechanically or hydraulically) to rotate so as to help the cutter tools 160 achieve a cutting action against one or more layers of the ground surface 108.

The power system 128 may be configured to power the aforesaid rotation of the milling drum 152. In this regard, the power system 128 may include an output shaft 168 to which a rotary power from a power source 172 of the power system 128 may be passed during the milling operation or during a working of the power source 172. The power system 128 may further include an endless flexible member 176, such as a drive belt, or the like device, that may be wound and/or tensioned around each of the output shaft 168 and the driveshaft 164—e.g., around pulleys 174 disposed correspondingly on or around the driveshaft 164 and the output shaft 168, as shown in FIG. 1. In that manner, the endless flexible member 176 may convey the rotary power from the output shaft 168 (that in turn receives power from the power source 172) to the driveshaft 164, causing the milling drum 152 to rotate and helping the cutter tools 160 to achieve the cutting action.

While rotating, the milling drum 152 may be lowered to contact the ground surface 108. In so doing, the cutter tools 160 may grind and scrape off one or more layers (e.g., top layers) of the ground surface 108 that the milling drum 152 may come in contact with. In so doing, said layers of the ground surface 108 may break into rubble, dust, and debris, and may result in the formation of the milled materials. In other words, the milling operation facilitates disintegration of one or more layers of the ground surface 108 so as to result in the production of milled materials and thus a milled roadway surface. The milling operation may be performed by the milling assembly 120 as the machine 100 moves over the ground surface 108 (e.g., see exemplary direction, T, of machine motion).

The conveyor system 132 is configured to receive the milled materials (e.g., produced during the milling operation) and convey said milled materials from the milling chamber 148 into a dump location or a dump body of a transport vehicle (e.g., a dump truck) (not shown) that may move ahead of the machine 100 during the milling operation. The conveyor system 132 may be a two conveyor system and may include a primary conveyor 180 and a secondary conveyor 184, although more or less conveyors may be contemplated. The primary conveyor 180 may be disposed closer to the milling chamber 148 of the milling assembly 120 so as to receive and clear the milled materials from the milling chamber 148, while the secondary conveyor 184 may be disposed in a manner to receive the milled materials from the primary conveyor 180. Also, the secondary conveyor 184 may be movable with respect to the chassis 116 so as to be panned and aligned with respect to the dump body of the dump truck. One or more aspects of the present disclosure are described in relation to the primary conveyor 180. Said description may be suitably applicable to the secondary conveyor 184, as well.

Referring to FIGS. 1, 2, and 3, the primary conveyor 180 may include an endless flexible member 188, such as a conveyor belt 188′. The endless flexible member may be formed from rubber, which may include fabric reinforcements, or the like material(s), now known or in the future developed, to convey the milled materials from the milling chamber 148 to the secondary conveyor 184. Further, the primary conveyor 180 may include a frame 192, one or more rollers (e.g., a roller 196), and the endless flexible member 188 may be wound and/or tensioned around an assembly of the frame 192 and the roller 196. The frame 192 may include a generally elongated profile with end regions 200 (e.g., a first end region 200′ and a second end region 200″). The end regions 200 may be oppositely disposed with respect to each other, as shown.

The roller 196 may be respectively rotatably coupled at the second end region 200″ of the frame 192 such that the roller 196 may be rotatable with respect to the frame 192. During a working of the primary conveyor 180, and as a milling operation may be in progress, the roller 196 may engage and enable the endless flexible member 188 to repeatedly turn and move around the frame 192 to help the endless flexible member 188 function as a conveyor to clear milled materials from the milling chamber 148 onto the secondary conveyor 184.

Apart from the roller 196 being rotatable with respect to the end region (e.g., second end region 200″) of the frame 192, the roller 196 may also be movable (e.g., linearly movable) with respect to the frame 192 (e.g., to the second end region 200″ of the frame 192). The movement of the roller 196 with respect to the frame 192 facilitates the roller 196 to pull and tension the endless flexible member 188 so as to maintain a proper working tension on the endless flexible member 188. In this regard, the second end region 200″ of the frame 192 may define a frame portion 204 and the roller 196 may define a roller portion 208.

In some embodiments, the frame portion 204 and the roller portion 208 may be corresponding regions or elements defined on the frame 192 and the roller 196. As an example, the second end region 200″ of the frame 192 may include a sliding bracket 212, while the roller portion 208 may define or include a bearing mount 220 movable or slidable on the sliding bracket 212. The frame portion 204 may be defined on the sliding bracket 212 away from the roller portion 208, as shown. The roller 196 may be rotatably supported on the bearing mount 220. In that manner, the roller 196 may be slid along the sliding bracket 212 relative to the frame 192 to move relative to the frame 192. Given the movable relationship between the roller 196 and the frame 192, the roller portion 208 may be movable with respect to the frame portion 204, as well, and such a movement may also pull and tension the endless flexible member 188 to maintain a proper working tension on the endless flexible member 188.

To move the roller portion 208 with respect to the frame portion 204 and to tension the endless flexible member 188, the conveyor system 132 may include a tensioning mechanism 224. The tensioning mechanism 224 may include one or more studs (e.g., a stud 228) and one or more nuts (e.g., see first nut 232 and second nut 234). The stud 228 may be fixedly coupled to the bearing mount 220 or to the roller portion 208 and may include a threaded portion 238 which may pass through an arm 242 of the sliding bracket 212 or the second end region 200″, thereby revealing a part 246 of the threaded portion 238 outwardly of the sliding bracket 212 or the second end region 200″. The first nut 232 may be a tightening nut that may be mounted and rotated around said part 246 of the threaded portion 238 and be abutted against the frame 192.

A tightening action enacted on the first nut 232 may result in a movement of the stud 228 in a direction outwards and away from the second end region 200″ of the frame 192. Given that the stud 228 may be fixedly coupled to the bearing mount 220, in process of said tightening action, a tightening of the stud 228 may cause the stud 228 to pull the bearing mount 220 and the roller 196 in a direction away from the frame 192, in turn tightening or tensioning the endless flexible member 188, enabling a proper working tension to be maintained on the endless flexible member 188, and allowing the endless flexible member 188 to function as a conveyor. The second nut 234 may be applied on the part 246 of the threaded portion 238 and be held or deployed adjacent to the first nut 232 to lock a position of the first nut 232.

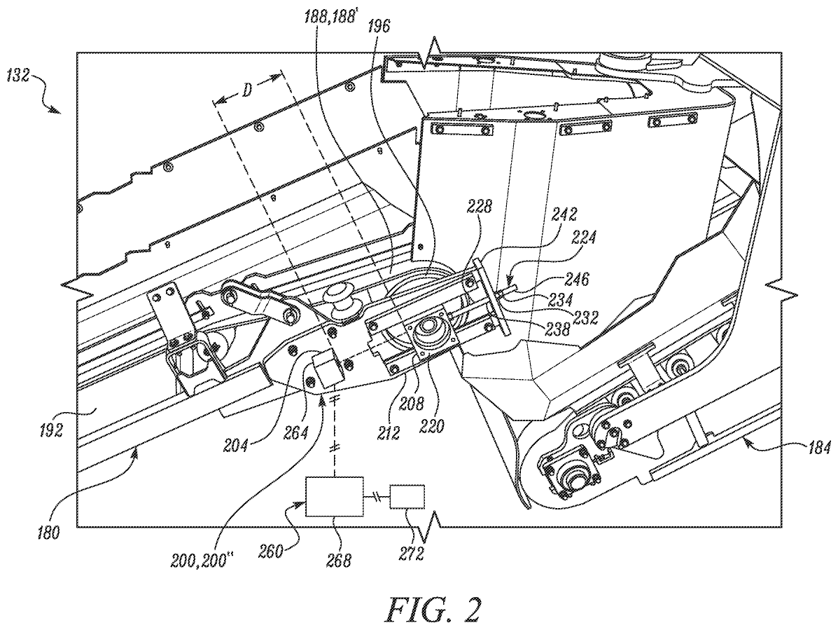

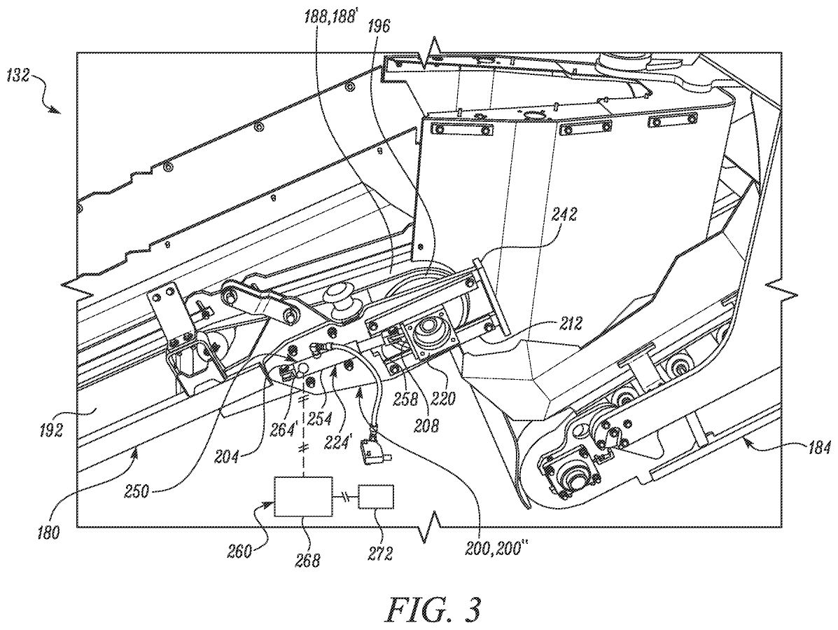

Referring to FIG. 3, in some embodiments, the conveyor system 132 may include a tensioning mechanism 224′ to perform a similar function as that of the tensioning mechanism 224. The tensioning mechanism 224′ may include a fluid actuator 250. The fluid actuator 250 may include a cylinder 254 and a rod 258 extendable with respect to the cylinder 254. As shown, the cylinder 254 may be coupled to (and may be part of) the frame portion 204 and the rod 258 may be coupled to (and may be part of) the roller portion 208. An influx of a fluid into the cylinder 254 may push the rod 258 away from and/or outwards of the cylinder 254, in turn pushing or moving the roller portion 208 also in a direction away from and/or outwards of the frame portion 204. In so doing, the roller portion 208 may be moved with respect to the frame portion 204 to tension the endless flexible member 188 and/or to maintain the proper working tension on the endless flexible member 188. Although the tensioning mechanisms 224, 224′ are illustrated to on one side of the primary conveyor 180 in the FIGS. 2 and 3, similar tensioning mechanisms may be provided on the other side (not viewable in FIGS. 2 and 3) of the primary conveyor 180, as well.

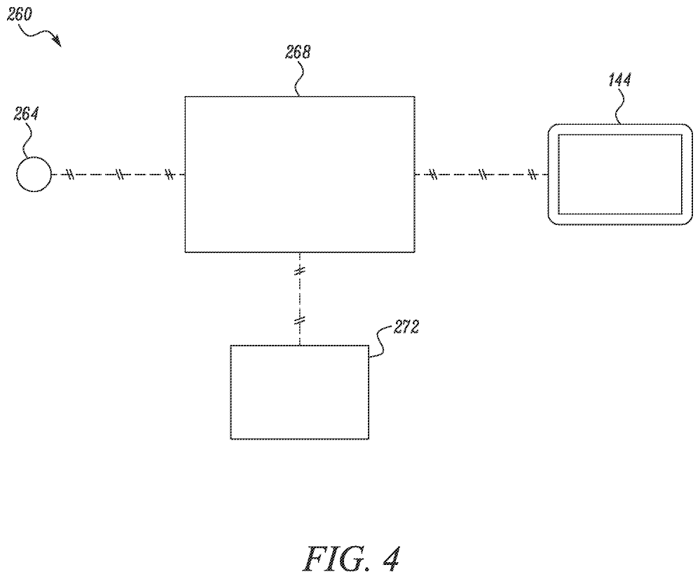

Referring to FIG. 4, owing to factors, such as harsh and/or rigorous operational conditions in and around the machine 100, the endless flexible member 188 may become slack over time and may slip over the frame 192 and/or the roller 196. Thus, the endless flexible member 188 may need maintenance after a period of use, which may include one or more of repairs or a replacement of the endless flexible member 188. One or more aspects of the present disclosure relates to a system 260 for predicting maintenance or a life (e.g., a remaining work life) of the endless flexible member 188. The system 260 includes one or more sensors (e.g., a sensor 264) and a controller 268.

The sensor 264 may be configured to detect a distance, D, (see FIG. 2) between the frame portion 204 and the roller portion 208, and thus may include a proximity sensor and/or a linear sensor. The sensor 264 may be mounted on one of the frame portion 204 and the roller portion 208 to detect the distance, D, from one of the frame portion 204 and the roller portion 208 to the other of the frame portion 204 and the roller portion 208. For example, and as shown, the sensor 264 may be mounted on the frame portion 204 so as to detect the distance, D, from the frame portion 204 to the roller portion 208. In this regard, the distance, D, may be a distance extending from a region of a mounting of the sensor 264 on the frame portion 204 up to a reference section on the roller portion 208. The reference section may be defined on the bearing mount 220, although it is possible that the reference section be situated at other areas on the roller portion 208.

When the fluid actuator 250 is applied as the tensioning mechanism 224′, the same sensor 264 (not shown in FIG. 3) may be applied to detect the distance, D. Alternatively, a sensor 264′ (similar to the sensor 264) may be mounted to one of the cylinder 254 and the rod 258 to detect a gap between the cylinder 254 and the rod 258. For example, the sensor 264′ may be mounted on the cylinder 254, as shown, so as to detect the gap between the cylinder 254 and the rod 258. In such a case, and in some embodiments, the distance, D, between the frame portion 204 and the roller portion 208 may correspond to or be exactly as the gap. In some embodiments, the distance, D, may be directly proportional to the gap and may be computable (e.g., by the controller 268) by obtaining a product of the gap with a gap coefficient. In this regard, the gap coefficient may be a predefined coefficient that may be determined based on a relation between a change in the distance, D, between the frame portion 204 and the roller portion 208 for every unit change in the gap between the cylinder 254 and the rod 258.

The controller 268 may be communicably coupled to the sensor 264. The controller 268 may also be communicably coupled to one or more other devices of the machine 100 such as the controls 140 and/or the input/output devices 144 provided in the operator station 124 of the machine 100. The controller 268 may also be communicably coupled to a memory 272 (which may be one of integral or external to the controller 268) so as to be able to extract or retrieve a set of instructions to perform a task associated with predicting the maintenance of the endless flexible member 188. In some embodiments, the controller 268 may be able to retrieve the set of instructions each time the machine 100 is active or when the input for initiating a milling operation is provided through one or more of the controls 140 or the input/output devices 144 in the operator station 124. In some embodiments, the controller 268 may be able to retrieve the set of instructions to perform the task when an instruction to predict the maintenance is separately (and/or specifically) obtained from one or more of the controls 140 and/or the input/output devices 144 of the operator station 124.

In response to the input and/or the instruction, the controller 268 may retrieve the set of instructions from the memory 272 to perform the task, as discussed above. With regard to the task, the controller 268 may be configured to compute a change in the distance, D, over time between the frame portion 204 and the roller portion 208 that is required to maintain the proper working tension on the endless flexible member 188. Further, the controller 268 may generate one or more alerts when a value associated with the change in the distance, D, exceeds one or more predetermined threshold values.

In some embodiments, the value may correspond to the change in the distance, D, itself, and the predetermined threshold values may correspond to predetermined threshold distances. In some embodiments, the controller 268 determines a percentage increase in a length of the endless flexible member 188 based on the change in the distance, D. The controller 268 further issues one or more notifications (e.g., as alerts) when the percentage increase correspondingly exceeds one or more predefined percentage increase thresholds. In such a case, the percentage increase may correspond to the value and the predefined percentage increase thresholds may correspond to the predetermined threshold values.

The alerts or notifications may be provided to one or more operators of the machine 100 through the input/output devices 144 provided in the operator station 124. The alerts or notifications may help one or more operators to review the remaining life of the endless flexible member 188. Details related to a working of the controller 268 in this regard and/or to an exemplary method of predicting the maintenance of the endless flexible member 188 is discussed by way of a flowchart 500 later.

The controller 268 may be communicably coupled to the machine's electronic control module (ECM) (not shown), such as a safety module or a dynamics module, or may be configured as a stand-alone entity. Optionally, the controller 268 may be integral and be one and the same as one of the ECMs of the machine 100. Further, the controller 268 may be a microprocessor-based device, and/or may be envisioned as an application-specific integrated circuit, or other logic devices, which provide controller functionality, and such devices being known to those with ordinary skill in the art.

In one example, it is possible for the controller 268 to include or be representative of one or more controllers having separate or integrally configured processing units to process a variety of data (or input or commands). In some embodiments, a transmission of data between the controller 268 and various other controllers and/or the sensor 264, the input/output devices 144, the controls 140, etc., may be facilitated wirelessly or through a standardized CAN bus protocol. Further, the controller 268 may be optimally suited for accommodation within certain machine panels or portions from where the controller 268 may remain accessible for ease of use, service, calibration, and repairs.

Processing units of the controller 268, to convert and/or process various input, command, signals, and/or the like, may include, but are not limited to, an X86 processor, a Reduced Instruction Set Computing (RISC) processor, an Application Specific Integrated Circuit (ASIC) processor, a Complex Instruction Set Computing (CISC) processor, an Advanced RISC Machine (ARM) processor, or any other processor.

Examples of the memory 272 may include a hard disk drive (HDD), and a secure digital (SD) card. Further, the memory 272 may include non-volatile/volatile memory units such as a random-access memory (RAM)/a read only memory (ROM), which may include associated input and output buses. The memory 272 may be configured to store various other instruction sets for various other functions of the machine 100, along with the set of instruction, discussed above.

### INDUSTRIAL APPLICABILITY

Owing to factors, such as harsh and/or rigorous operational conditions in and around the machine 100, the endless flexible member 188 may become slack on the frame 192 and/or the roller 196 over time, potentially making the endless flexible member 188 lose its grip on the roller 196 and may end up slipping on the roller 196. For this reason, a proper working tension may be maintained on the endless flexible member 188 to allow the endless flexible member 188 to function properly as a conveyor. In this regard, one or more of the tensioning mechanisms 224, 224′ may be used to tighten and/or tension the endless flexible member 188 to achieve the proper working tension.

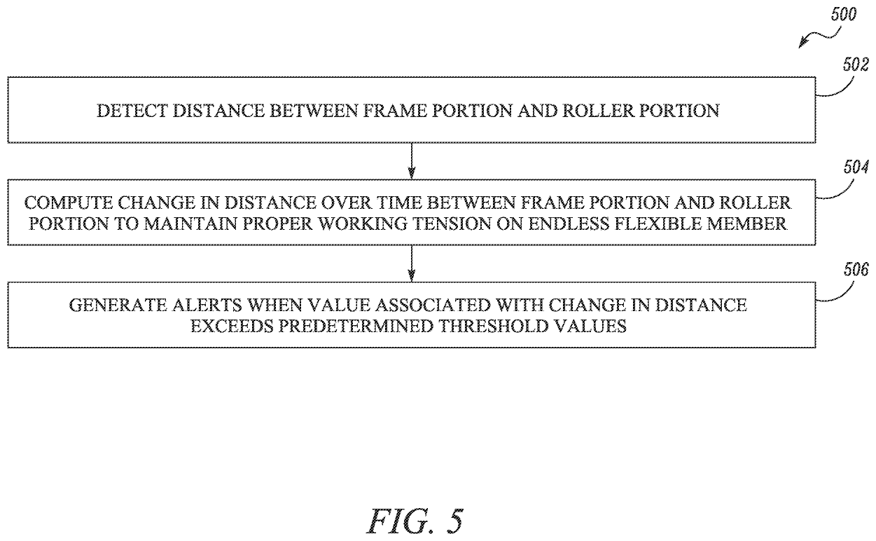

However, each time a tightening and/or a tensioning operation is performed, the endless flexible member 188 may commensurately stretch, may lose integrity and strength, and may become weaker, to the point of a possible failure or tear, potentially leading to conveyor downtime (i.e., downtime of the primary conveyor 180). Such conveyor downtime may be avoided if it is timely determined as to when or how long after the endless flexible member 188 needs a repair or a replacement. With reference to FIG. 5, the exemplary method for predicting maintenance or life of the endless flexible member 188 of the machine 100 is described. The method is described with reference to a flowchart 500 in FIG. 5 and the same is discussed also in conjunction with FIGS. 1 to 4. The method starts at block 502.

At block 502, the sensor 264 may detect the distance, D, between the frame portion 204 and the roller portion 208. If the sensor 264 is applied, the distance, D, between the frame portion 204 and the roller portion 208 may be computed as a distance between the region of mounting of the sensor 264 on the frame portion 204 up to a reference section defined on the roller portion 208 (e.g., on the bearing mount 220). In other cases, if the fluid actuator 250 is applied as part of the tensioning mechanism (e.g., tensioning mechanism 224′), the sensor 264′ may be provided within the fluid actuator 250 and may be coupled or mounted to the cylinder 254 so as to detect the gap from the cylinder 254 to the rod 258. In such a case, the gap may correspond to or be equal to the distance, D. In some embodiments, the gap may be used (e.g., by the controller 268) to compute the distance, D. For example, the controller 268 may arrive at the distance, D, by obtaining a product of the gap and the gap coefficient. The method proceeds to block 504.

At block 504, the controller 268 may compute a change in the distance, D, over time between the frame portion 204 and the roller portion 208 that is required to maintain proper working tension on the endless flexible member 188. To compute the change in the distance, D, the controller 268 may determine an initial distance, D′, between the frame portion 204 and the roller portion 208 at an initial setting of the frame portion 204 and the roller portion 208 in which the endless flexible member 188 is suitably tensioned. For example, the initial setting may relate to a setting of the frame portion 204 and the roller portion 208 at the time the endless flexible member 188 was first installed around the frame 192 and the roller 196 with the proper working tension.

As the endless flexible member 188 may wear out, develop slack, and/or may slip with respect to the roller 196 over time, one or more of the tensioning mechanism 224, 224′, as applicable, may be applied to move the roller portion 208 away from the frame portion 204 to engage, pull, and re-tension, the endless flexible member 188 and re-achieve the proper working tension. In so doing, a new setting of the frame portion 204 and the roller portion 208 may be attained. At this new setting, the controller 268 may determine a new distance, D″, between the frame portion 204 and the roller portion 208. In some embodiments, to determine the distances, D′ and D″, the controller 268 may be configured to continuously or periodically (e.g., in regular intervals) retrieve data from the sensor 264, 264′, as applicable. Further, once the distances, D′ and D″, have been determined, the controller 268 may deduct the initial distance from the new distance (i.e., D″-D′) to determine the change in the distance, D. The method proceeds to block 506.

At block 506, the controller 268 generates alerts when a value associated with the change in the distance, D, exceeds one or more predetermined threshold values. As noted above, in some embodiments, the value may correspond to the change in the distance, D, itself, and the predetermined threshold values may correspond to predetermined threshold distances. As an example, if an initial length or an initial circumferential length of the endless flexible member 188 were equal to 10 meters (m) or 10000 millimeters (mm) and if a predetermined threshold distance were equal to 50 mm, as the change in the distance, D, increases from anywhere less than 50 mm to become equal to or exceed 50 mm, the controller 268 may generate an alert. In some embodiments, the controller 268 may generate multiple alerts or one or more subsequent alerts as and when subsequent changes in the distance, D, become equal to or exceed corresponding predetermined threshold distances (one or more of which could also be different from 50 mm). It may be noted that such alerts may be issued through the input/output devices 144 and may be in the form of one or more of an audible alert, a visual alert, a haptic feedback through one or more devices, or a combination of these. Such alerts could also be sent to one or more remote devices, e.g., a smartphone or a remote workstation.

In some embodiments, to generate the alerts, the controller 268 may determine a percentage increase in a length of the endless flexible member 188 based on the change in the distance, D. In this regard, when the endless flexible member 188 is installed on the primary conveyor 180, the controller 268 may be fed or provided (e.g., manually) with a circumferential length (e.g., an initial length or an initial circumferential length) of the endless flexible member 188. In some embodiments, it is possible for the controller 268 to estimate and set or optimize the initial circumferential length of the endless flexible member 188 based on the one or more machine parameters, e.g., a geometry of the primary conveyor 180.

Once the initial circumferential length is set and once the change in the distance, D, is determined, the controller 268 may estimate a corresponding stretch in the endless flexible member 188—i.e., the stretch arising because of the change in the distance, D, between the frame portion 204 and the roller portion 208 to determine the percentage increase. The stretch may be obtained as a product of the change in the distance, D, and a predetermined coefficient. In some embodiments, the predetermined coefficient may be 2 (two) provided that the circumferential length of the endless flexible member 188 grows twice as much as the distance, D, or 2 times for every unit change in the distance, D. As an example, the endless flexible member 188 grows 2 (mm) longer for every 1 mm of change in the distance, D. Depending upon a geometry of the primary conveyor 180, or other factors, however, the predetermined coefficient may differ from 2 (two), and, in some cases, the predetermined coefficient may be higher or lower than 2 (two).

If a tensioning mechanism (not shown) similar to any of the tensioning mechanisms 224, 224′ is provided on the other side (not shown) of the primary conveyor 180, the controller 268 may determine an amount corresponding to the aforesaid stretch as a first side amount of the stretch. The controller 268 may then determine an amount corresponding to a stretch at the other side of the primary conveyor 180, in a similar manner as discussed above, and determine an amount corresponding to said stretch at the other side as a second side amount of the stretch. To arrive at a final amount of the stretch, the controller 268 may obtain an average of the first side amount of the stretch and the second side amount of the stretch.

Further, to determine the percentage increase in the circumferential length of the endless flexible member 188, the controller 268 may be configured to divide the stretch (e.g., the final amount of the stretch) with the initial circumferential length of the endless flexible member 188 to obtain a deduced value. Once the deduced value is obtained, the controller 268 may obtain a product of the deduced value with 100 (one hundred) and may set said product as the percentage increase.

Further, the controller 268 issues an alert by way of a notification if or when the percentage increase exceeds a predefined percentage increase threshold. In some embodiments, the controller 268 issues multiple notifications when the percentage increase correspondingly exceeds multiple predefined percentage increase thresholds. As noted above, in such a case, the percentage increase may correspond to the value and the predefined percentage increase thresholds may correspond to the predetermined threshold values. Such notifications may be issued through the input/output devices 144 and may be in the form of one or more of an audible notification, a visual notification, a haptic feedback through one or more devices, or a combination of these. Such notifications could also be sent to one or more remote devices, e.g., a smartphone or a remote workstation. The method ends at block 506.

An exemplary scenario will be now described. For this exemplary scenario, it will be assumed that the initial circumferential length of the endless flexible member 188 is equal to 10 meters (m) or 10000 mm and the predefined percentage increase thresholds are set at the sequential occurrence of each of: a percentage increase in a length of the endless flexible member 188 of 1 (one) percent with respect to the initial circumferential length; a percentage increase in a length of the endless flexible member 188 of 2 (two) percent with respect to the initial circumferential length; a percentage increase in a length of the endless flexible member 188 of 3 (three) percent with respect to the initial circumferential length; and a percentage increase in a length of the endless flexible member 188 of 4 (four) percent with respect to the initial circumferential length.

Further, it may be assumed that at the percentage increase of 4 (four) percent, the controller 268 may issue a notification to replace the endless flexible member. This may imply that a stretch of 400 mm or a total circumferential length of the endless flexible member 188 when equal to 10400 mm (i.e., 10000 mm+400 mm), may be the maximum permissible length that the endless flexible member 188 can achieve before wearing out totally, and thus may require a replacement. Additionally, it may also be assumed that for every 1 mm increase in the distance between the frame portion 204 and the roller portion 208, the circumferential length of the endless flexible member 188 increases by 2 mm.

Over time, as the endless flexible member 188 may wear out, become slack over the frame 192, lose its grip and end up slipping on the roller 196, the tensioning mechanisms 224, 224′, as applicable, may be used to tighten and/or tension the endless flexible member 188 to re-achieve the proper working tension. In process of tensioning the endless flexible member 188, as the distance, D, between the frame portion 204 and the roller portion 208 increases up to 50 mm, the controller 268 may issue the first notification—this is because the 50 mm increase in the distance, D, means a 100 mm increase in the circumferential length of the endless flexible member 188 and a corresponding percentage increase of 1 (one) percent. In other words, for 50 mm increase in distance, D, the controller 268 may notify that 75 percent of life of the endless flexible member is remaining. Similarly, for 100 mm increase in distance, D, the controller 268 may notify that 50 percent of life of the endless flexible member 188 is remaining; for 150 mm increase in distance, D, the controller 268 may notify that 25 percent of life of the endless flexible member 188 is remaining; for 200 mm increase in distance, D, the controller 268 may notify that 0 percent of life of the endless flexible member 188 is remaining and that the endless flexible member 188 is worn out and should be replaced. The values and assumptions provided in the above example are purely exemplary, are provided for illustrative purposes alone, and can include other values and assumptions. Additionally, there may be more than or less than four notifications.

With the system 260, operators, site supervisor, etc., can effectively and proactively predict when a maintenance for the endless flexible member 188 is due. Such a prediction allows operators of the machine 100 to effectively set preventive maintenance schedules, prevent unscheduled machine downtime, and avoid any undue loss in productivity.

Further, a person skilled in the art can make any suitable modification or optimization to the system 260 so as to make the system 260 applicable to predict maintenance in various other endless flexible members without departing from the scope and spirit of the claimed subject matter. For example, the endless flexible member 176 may use a tensioning mechanism that is similar to the tensioning mechanism 224′ and may include a fluid actuator 350 that positions or pushes a roller 308 against a portion of the endless flexible member 176 to tension the endless flexible member 176. A frame portion and a roller portion corresponding to an arrangement of the endless flexible member 176 may be determined, and a change in distance (e.g., an angular distance) therebetween may be computed. Thence, a method (as discussed for the system 260) similar to the one described above can be used to predict the maintenance of the endless flexible member 176, as well. Further, aspects described corresponding to the system 260 above can also be suitably applied to other endless flexible members, such as conveyor chains (not shown) that are commonly used for transferring a paving material from a hopper to a screed of asphalt pavers for a compaction of the paving material over a ground surface. Additionally, aspects described in the present disclosure may also be appropriately applied to crawler tracks, which may include tracks made either of steel, rubber, or a combination of the two, and which may form part of the traction devices 136 of the machine 100.

It will be apparent to those skilled in the art that various modifications and variations can be made to the method and/or system of the present disclosure without departing from the scope of the disclosure. Other embodiments will be apparent to those skilled in the art from consideration of the specification and practice of the method and/or system disclosed herein. It is intended that the specification and examples be considered as exemplary only, with a true scope of the disclosure being indicated by the following claims and their equivalent.

What is claimed is:

1. A system for predicting maintenance of an endless flexible member of a road construction machine, the system comprising:
a sensor to detect a distance between a frame portion and a roller portion, wherein the roller portion is movable with respect to the frame portion to tension the endless flexible member, the endless flexible member configured to convey materials or power in the road construction machine; and
a controller communicably coupled to the sensor, the controller configured to:
compute a change in the distance over time between the frame portion and the roller portion that is required to maintain proper working tension on the endless flexible member; and
generate one or more alerts when a value associated with the change in the distance exceeds one or more predetermined threshold values.

2. The system of claim 1, wherein the sensor is a proximity sensor and is configured to be mounted to the frame portion or to the roller portion to detect the distance from one of the frame portion and the roller portion to the other of the frame portion and the roller portion.

3. The system of claim 1, wherein the road construction machine includes a fluid actuator having a cylinder and a rod, the cylinder being coupled to one of the frame portion and the roller portion and the rod being coupled to the other of the frame portion and the roller portion,
wherein the rod is extendable with respect to the cylinder for moving the roller portion with respect to the frame portion to tension the endless flexible member.

4. The system of claim 3, wherein the sensor is a proximity sensor and is configured to be mounted to one of the cylinder and the rod to detect a gap from one of the cylinder and the rod to the other of the cylinder and the rod,
wherein the distance between the frame portion and the roller portion corresponds to or is directly proportional to the gap.

5. The system of claim 1, wherein to compute the change in the distance between the frame portion and the roller portion, the controller is configured to:
at an initial setting of the frame portion and the roller portion in which the endless flexible member is suitably tensioned, determine an initial distance between the frame portion and the roller portion;
at a new setting of the frame portion and the roller portion attained by a movement of the roller portion with respect to the frame portion to re-tension the endless flexible member, determine a new distance between the frame portion and the roller portion; and
deduct the initial distance from the new distance to determine the change in the distance.

6. The system of claim 1, wherein to generate the one or more alerts, the controller is configured to:
determine a percentage increase in a length of the endless flexible member based on the change in the distance; and
issue one or more notifications when the percentage increase correspondingly exceeds one or more predefined percentage increase thresholds,
wherein the percentage increase corresponds to the value and the one or more predefined percentage increase thresholds corresponds to the one or more predetermined threshold values.

7. The system of claim 6, wherein to determine the percentage increase in the length of the endless flexible member, the controller is configured to estimate a stretch in the endless flexible member by obtaining a product of the change in the distance and a predetermined coefficient.

8. The system of claim 7, wherein to determine the percentage increase in the length of the endless flexible member, the controller is configured to divide the stretch with an initial length of the endless flexible member.

9. A road construction machine, comprising:
a chassis;
an implement assembly supported by the chassis;
a power system to generate and convey power to the implement assembly for a road construction operation;
a conveyor system to convey materials produced from the road construction operation to a dump location;
an endless flexible member to convey the power or the materials;
a frame portion and a roller portion, the roller portion being movable with respect to the frame portion to tension the endless flexible member;
a system for predicting maintenance of the endless flexible member, the system including:
a sensor to detect a distance between the frame portion and the roller portion; and
a controller communicably coupled to the sensor, the controller configured to:
compute a change in the distance over time between the frame portion and the roller portion that is required to maintain proper working tension on the endless flexible member; and
generate one or more alerts when a value associated with the change in the distance exceeds one or more predetermined threshold values.

10. The road construction machine of claim 9, wherein the sensor is a proximity sensor and is mounted to the frame portion or to the roller portion to detect the distance from one of the frame portion and the roller portion to the other of the frame portion and the roller portion.

11. The road construction machine of claim 9 further including a fluid actuator having a cylinder and a rod, the cylinder being coupled to one of the frame portion and the roller portion and the rod being coupled to the other of the frame portion and the roller portion,
wherein the rod is extendable with respect to the cylinder for moving the roller portion with respect to the frame portion to tension the endless flexible member.

12. The road construction machine of claim 11 wherein the sensor is a proximity sensor and is mounted to one of the cylinder and the rod to detect a gap from one of the cylinder and the rod to the other of the cylinder and the rod,
wherein the distance between the frame portion and the roller portion corresponds to or is directly proportional to the gap.

13. The road construction machine of claim 9, wherein to compute the change in the distance between the frame portion and the roller portion, the controller is configured to:
at an initial setting of the frame portion and the roller portion in which the endless flexible member is suitably tensioned, determine an initial distance between the frame portion and the roller portion;
at a new setting of the frame portion and the roller portion attained by a movement of the roller portion with respect to the frame portion to re-tension the endless flexible member, determine a new distance between the frame portion and the roller portion; and
deduct the initial distance from the new distance to determine the change in the distance.

14. The road construction machine of claim 9, wherein to generate the one or more alerts, the controller is configured to:
determine a percentage increase in a length of the endless flexible member based on the change in the distance; and
issue one or more notifications when the percentage increase correspondingly exceeds one or more predefined percentage increase thresholds,
wherein the percentage increase corresponds to the value and the one or more predefined percentage increase thresholds corresponds to the one or more predetermined threshold values.

15. The road construction machine of claim 14, wherein to determine the percentage increase in the length of the endless flexible member, the controller is configured to estimate a stretch in the endless flexible member by obtaining a product of the change in the distance and a predetermined coefficient.

16. The road construction machine of claim 15, wherein to determine the percentage increase in the length of the endless flexible member, the controller is configured to divide the stretch with an initial length of the endless flexible member.

17. A method for predicting maintenance of an endless flexible member of a road construction machine, the method comprising:
detecting, by a sensor, a distance between a frame portion and a roller portion, wherein the roller portion is movable with respect to the frame portion to tension the endless flexible member, the endless flexible member configured to convey materials or power in the road construction machine;
computing, by a controller, a change in the distance over time between the frame portion and the roller portion that is required to maintain proper working tension on the endless flexible member; and
generating, by the controller, one or more alerts when a value associated with the change in the distance exceeds one or more predetermined threshold values.

18. The method of claim 17, wherein generating the one or more alerts includes:
determining, by the controller, a percentage increase in a length of the endless flexible member based on the change in the distance; and
issuing, by the controller, one or more notifications when the percentage increase correspondingly exceeds one or more predefined percentage increase thresholds,
wherein the percentage increase corresponds to the value and the one or more predefined percentage increase thresholds corresponds to the one or more predetermined threshold values.

19. The method of claim 18, wherein determining the percentage increase in the length of the endless flexible member includes estimating, by the controller, a stretch in the endless flexible member by obtaining a product of the change in the distance and a predetermined coefficient.

20. The method of claim 19, wherein determining the percentage increase in the length of the endless flexible member includes dividing, by the controller, the stretch with an initial length of the endless flexible member.
